(19) United States
(12) Patent Application Publication
(10) Pub. No.: US 2003/0148070 A1
(43) Pub. Date: Aug. 7, 2003

(54) CARRIER PLATE FOR MICRO-HYBRID CIRCUITS

(76) Inventors: ULRICH GOEBEL, REUTLINGEN (DE); ELMAR HUBER, EISENACH (DE); ALBERT-ANDREAS HOEBEL, REUTLINGEN (DE)

Correspondence Address: KENYON & KENYON, ONE BROADWAY, NEW YORK, NY, 10004, US

(21) Appl. No.: 09/508,572

(22) PCT Filed: Sep. 10, 1998
(86) PCT No.: PCT/DE98/02678

(30) Foreign Application Priority Data
Sep. 13, 1997 (DE) 197 40 330.1

(51) Int. Cl. B32B 3/00

(52) U.S. Cl. 428/156

(57) ABSTRACT

The invention relates to a substrate board (2) for micro hybrid integrated circuits (7) having a ceramic body (3). According to the present invention, provision is made that the ceramic body (3) is a porous body, whose cavities are filled with aluminum. Due to the relatively small difference in thermal expansion coefficients of the substrate board (2) and the micro hybrid integrated circuit (7), a very good thermal bond of the micro hybrid integrated circuits (7) to the substrate board (2) is possible.

### BACKGROUND INFORMATION

The invention relates to a substrate board for micro hybrid integrated circuits having a ceramic body.

A substrate board of the species is disclosed in U.S. Pat. No. 5,576,934. It is composed of a ceramic board, which is covered on its upper and lower sides by a metallic skin made of copper. The ceramic board is provided with recesses, which are bridged by the copper skin. These recesses function to receive components arranged on the lower side of the micro hybrid integrated circuits. In mounting micro hybrid integrated circuits on the substrate board, the copper skin is pressed in in the area of the recesses, so that these components, particularly heat-producing integrated circuits, are accommodated in the recesses. The components are bonded to the substrate board using heat-conducting substances, in particular heat-conducting adhesive agents, that are applied between the components and the substrate board. In this manner, the heat generated by the components can be removed directly via the substrate board.

However, the design of micro hybrid integrated circuits is individually distinctive. Therefore, no standardized substrate boards can be used, but rather they must be provided with the appropriate recesses individually. The manufacture of substrate boards of this type is therefore very cumbersome and, consequently, also very expensive.

In addition, a general problem lies in the thermal bonding of the micro hybrid integrated circuits to the substrate board. This is due to the varying thermal expansion coefficients. The solution described above involving heat-conducting intermediate layers requires additional components and process steps. Therefore, it is also very cumbersome and expensive.

### ADVANTAGES OF THE INVENTION

In contrast, the substrate board according to the present invention, whose ceramic body is a porous body whose cavities are infiltrated using a metallic substance, has the advantage that a very good thermal bonding of components to the substrate surface of a micro hybrid integrated circuit is possible. The substrate board is distinguished by high thermal conductivity and a low thermal expansion coefficient. Due to the relatively small difference between the thermal expansion coefficients of micro hybrid integrated circuits and substrate boards, the two can be joined to each other using a very thin adhesive layer, and without great deformations. It is no longer necessary to use special heat-conducting substances.

Substrate boards of this type are produced using an infiltration process, in which the cavities are filled with the metal. This type of material is known under the designation “Metal Matrix Composite” (hereinafter: MMC).

As a result of the measures cited in the subclaims, advantageous refinements and improvements of the substrate board indicated in claim 1 are possible.

It is particularly advantageous to coat the substrate board with a supplemental metallic skin, which can be provided, in particular, with layout-specific depressions. In this way, it is possible using a standardized ceramic body to obtain surfaces having layout-specific patterns. The manufacture of layout-specific substrate boards of this type is therefore simple and cost-effective.

A preferred material is Al—Si-Cermet. It is composed of a porous SiC ceramic, whose cavities are filled with aluminum. A substrate board made thereof can then be covered by a metallic skin of aluminum. Since aluminum is a metal that is easy to process, the layout-specific patterns can be laid down both by a mechanical processing of the aluminum layer as well as by inserts in the infiltration or casting tools. Thus, changes in the surface patterns can be realized rapidly. In this way, the manufacturing process also becomes simple and cost-effective.

Substrate boards of this type can be inserted into larger aluminum castings, including, for example, locally. In this manner, it is possible to realize a bonding of the substrate board, adjusted with respect to the thermal expansion coefficient, to a cast housing for micro hybrid control units. As a result, the number of assembly steps is reduced. In addition, ceramic material can be saved. The impact resistance of the MMCs is increased. Finally, by analogy to pure castings, it is possible to form molded parts freely.

Embedding in castings in this manner is possible not only using Al—Si-Cermet, but using all metals from which MMCs can be manufactured.

In addition, supplemental insulating layers and/or metallic layers can be applied to the substrate board. In connection with supplemental insulation layers, an insulation of the micro hybrid integrated circuit with respect to the substrate board is possible at a high dielectric strength. In this manner, the ESD stability is increased. Components of this type can be used for high-voltage applications.

Additional metallic layers offer the possibility of introducing an additional shielding layer (e.g., electronic ground) independent of the potential of the substrate board.

In addition, the metallic skin can be patterned, so that the substrate board can also be used as a wiring plane. This measure also saves manufacturing costs.

The substrate board according to the invention, therefore, in a simple, cost-effective manner, permits a multiplicity of variations for micro hybrid integrated circuits, depending on the concrete application.

### DRAWING

In the following, the invention is explained in greater detail on the basis of exemplary embodiments with reference to the drawings. The following are the contents:

FIG. 1 shows a schematic sectional view of a first exemplary embodiment of a substrate board according to the invention having a micro hybrid integrated circuit mounted on it;

FIG. 2 shows a depiction of a second exemplary embodiment, analogous to FIG. 1;

FIG. 3 shows a depiction of a third exemplary embodiment, analogous to FIG. 1.

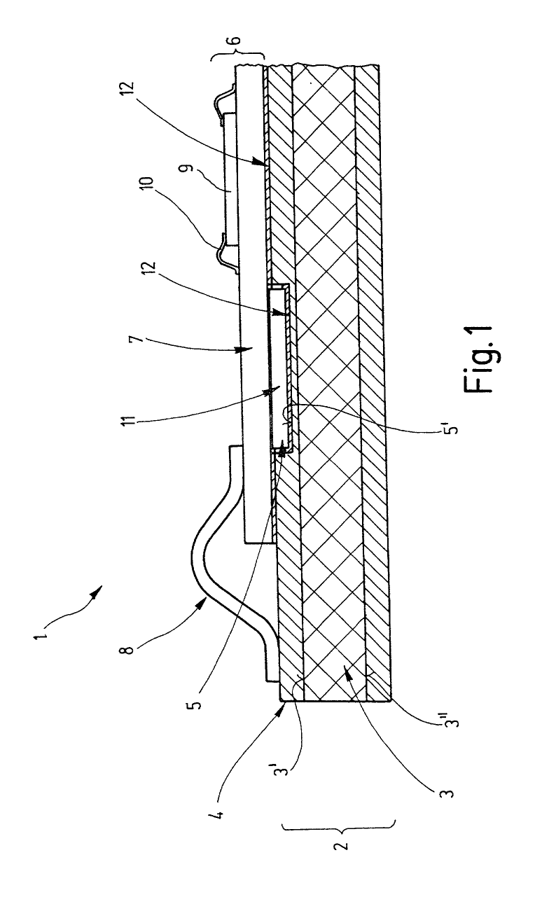

FIG. 1 shows a sectional view of a unit 1 according to the invention having a substrate board 2 according to the invention in the form of an MMC heat sink and an electronic component 6.

Substrate board 2 is composed of a ceramic body 3 made of Al—Si-Cermet. In this context, it is a question of a porous SiC ceramic, whose cavities are infiltrated by aluminum. The manufacturing process is generally known; these materials can be obtained, e.g., from the Alcoa or Lanxide companies. Ceramic body 3, depending on the application, is roughly 0.3 to 2 mm thick.

Ceramic body 3 is covered on its upper side 3′ and on its lower side 3″ by a metallic skin 4 of aluminum. The layer thickness of metallic skin 4 is roughly 0.6 mm.

Component 6, schematically depicted in FIG. 1, is composed of a multilayer, micro hybrid integrated circuit 7 and two integrated switching circuits 9 and 11. Micro hybrid integrated circuits 7 of this type are generally composed of a ceramic material and can have various components (such as resistors or transistors), which are integrated in the individual layers. They are connected by wires 8, e.g., Al wire bonds, to external terminals not depicted here or to conductive patterns on metallic skin 4 of substrate board 2.

Micro hybrid integrated circuit 7 is furnished in the exemplary embodiment with two integrated switching circuits 9 and 11, e.g., flip-chip ICs. Switching circuit 9 is arranged on upper side 7′ of micro hybrid integrated circuit 7 and is connected via wires 10 to conductive patterns on upper side 7′ of the micro hybrid integrated circuit. Switching circuit 11 is located on lower side 7″ of micro hybrid integrated circuit 7.

Metallic skin 4 has a depression 5, which accommodates integrated switching circuit 11 on lower side 7″ of micro hybrid integrated circuit 7. The layer thickness of metallic skin 4 at this location is only 0.1 to 0.2 mm. Depression 5 is layout-specific, i.e., with respect both to its size as well as to its position in metallic skin 5, it is adjusted individually to the size and position of switching circuit 11 on lower side 7″ of micro hybrid integrated circuit 7. Depression 5 can be produced using a variety of methods. In small series, a mechanical processing, e.g., milling, is appropriate. In particular, aluminum can be mechanically processed very easily. Thus depression 5 can also be rapidly adjusted to changes in the layout of micro hybrid integrated circuit 4. A further possibility that is advantageous particularly in large series, lies in creating depression 5 during the manufacture of substrate board 2, e.g., using inserts in the infiltration or casting tool.

Substrate board 2 according to the present invention is distinguished by high thermal conductivity and a low thermal expansion coefficient, which is comparable to that of the micro hybrid integrated circuit. Therefore, it is sufficient to fix micro hybrid integrated circuit 7 on substrate board 2 without prestressing using only a thin layer of a conductive adhesive 12. In resulting unit 1, as a result of the comparable thermal expansion coefficients, no significant stresses arise which could impair the strength of the bond between micro hybrid integrated circuit 7 and substrate board 2 to a relevant degree.

As a result of the thin layer of conductive adhesive, the heat produced by switching circuits 9, 11 can also be directly dissipated to substrate board 2 according to the invention, without necessitating the interposition of a layer made of a special heat-conducting substance. Since substrate board 2 according to the invention is itself highly heat-conducting, the heat can also be rapidly and effectively dissipated to the outside.

In mounting micro hybrid integrated circuit 7 on substrate board 2, switching circuit 11 is also fixed in depression 5 using conductive adhesive 12.

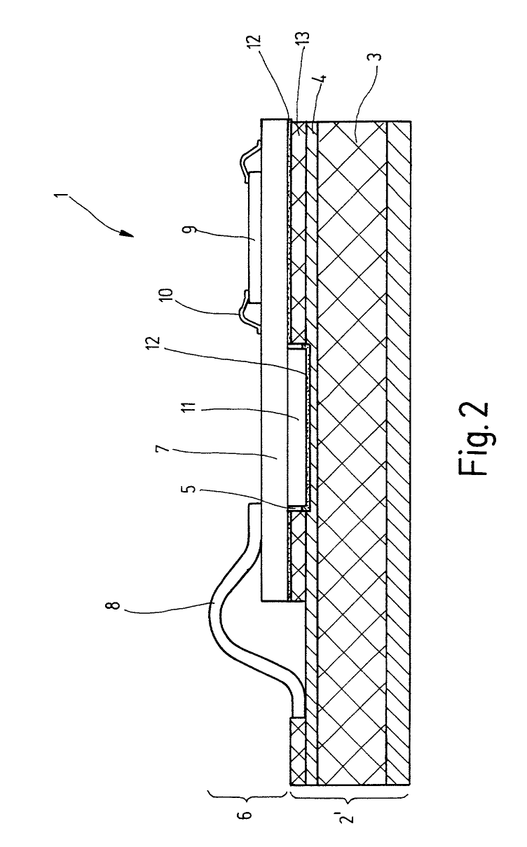

FIG. 2 depicts a second exemplary embodiment of a substrate board 2′ in essentially the same arrangement as in FIG. 1. The sole difference lies in the fact that on metallic skin 4 of substrate board 2′, provision is made for an insulating layer 13, e.g., made of a ceramic material or a plastic. Micro hybrid integrated circuit 7 is secured on this layer 13. Arrangements of this type increase the ESD stability and are suitable for high-voltage applications.

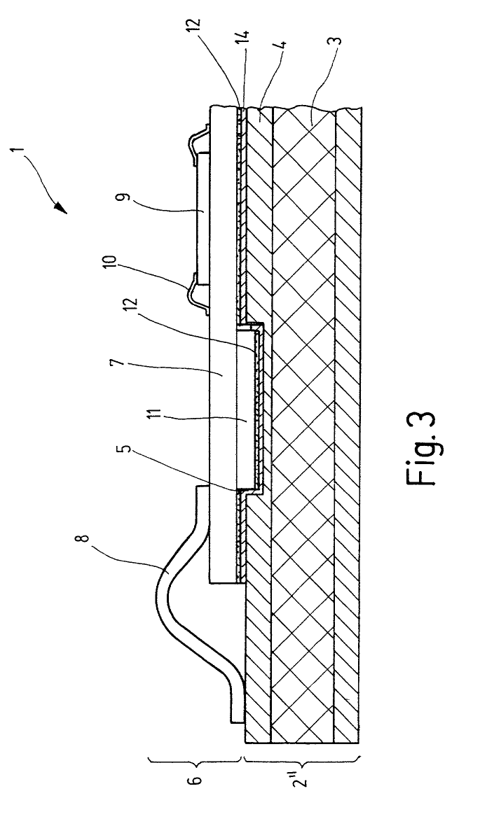

FIG. 3 depicts a further exemplary embodiment of a substrate board 2″ according to the invention, in which on metallic skin 4 a further metallic layer 14 is applied. Layer 14 is at a different electrical potential than substrate board 2. Layers 14 of this type offer an additional shielding layer independent of the potential of substrate board 2 in FIG. 1.

1. A substrate board (2) for micro hybrid integrated circuits (7) having a porous ceramic body (3) having cavities, the cavities being infiltrated by a metallic substance and the ceramic body (3) being covered by a metallic skin (4),
characterized in that the metallic skin (4) has one or more areas of reduced layer thickness, which form layout-specific depressions (5) for accommodating components (11) of the micro hybrid integrated circuits (7).

2. The substrate board as recited in claim 1,
characterized in that the layer thickness of the metallic skin (4) is roughly 0.4 to 0.8 mm, preferably roughly 0.6 mm.

3. The substrate board as recited in one of the preceding claims,
characterized in that the layer thickness of the areas is roughly 0.1 to 0.2 mm.

4. The substrate board as recited in one of the preceding claims,
characterized in that the metal used is aluminum.

5. The substrate board as recited in claim 4,
characterized in that it is inserted locally in certain areas of an aluminum casting.

6. The substrate board as recited in one of the preceding claims,
characterized in that it has at least one supplemental insulating layer (13) and/or at least one supplemental metallic layer (14).
